(19) United States
(12) Patent Application Publication
(10) Pub. No.: US 2026/0292536 A1
(43) Pub. Date: Sep. 24, 2026

(54) WIRELESS NETWORK MEDIA RENDERING USING MACHINE LEARNING TECHNIQUES

(71) Applicant: T-Mobile USA, Inc., Bellevue, WA (US)

(72) Inventor: Zheng Cai, Fairfax, VA (US)

(21) Appl. No.: 19/086,428

(22) Filed: Mar. 21, 2025

(51) Int. Cl. H04W 24/02; H04L 5/00

(52) U.S. Cl. CPC H04W 24/02; H04L 5/0005

(57) ABSTRACT

Systems and methods for duplicating media using machine learning are disclosed herein. A system can receive data for duplicating media previously generated on a remote device using a first model executing on a remote device. The system can extract parameters including a model identifier and model-specific parameters, such as prompts used in a previous session to generate the media and/or a seed value indicative of randomized weights used in the first model. The system can identify a second model corresponding to the first model from a plurality of models and reconfigure weights of the second model using the seed value. The system can input the prompts into the second model to generate regenerated media and cause the regenerated media to be rendered at a user device.

### BACKGROUND

A telecommunications network is established via a complex arrangement and configuration of many cell sites that are deployed across a geographical area. For example, there can be different types of cell sites (e.g., macro cells, micro cells, and so on) positioned in a specific geographical location, such as a city, neighborhood, and so on. These cell sites strive to provide adequate, reliable coverage for mobile devices (e.g., smartphones, tablets, and so on) via different frequency bands and radio networks such as a Global System for Mobile (GSM) mobile communications network, a code/time division multiple access (CDMA/TDMA) mobile communications network, a third, fourth, or fifth generation (3G/4G/5G) mobile communications network (e.g., General Packet Radio Service (GPRS)/enhanced GPRS ((EGPRS), Enhanced Data rates for GSM Evolution (EDGE), Universal Mobile Telecommunications System (UMTS), or long-term evolution (LTE) network), Institute of Electrical and Electronics Engineers (IEEE) 802.11 (Wi-Fi), or other communications networks. The devices can seek access to the telecommunications network for various services provided by the network, such as services that facilitate the transmission of data over the network and/or provide content to the devices.

Networks such as these facilitate communications between millions of devices, including communications that include media such as audio, video, or images. In particular, with growing interconnectivity and development of mixed reality (MR), virtual reality (VR), and augmented reality (AR) as well as spatial audio, the amount of data being transmitted and rendered in real time grows exponentially. As wireless communication moves toward 6G, these use cases require large bandwidth and ultra-low latency, ultimately putting computational and resource strains on telecommunications networks.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3A is a block diagram illustrating a suitable computing environment for duplicating media using a model, in accordance with embodiments herein.

FIG. 3B is a block diagram illustrating the components of an exemplary media rendering system, in accordance with embodiments herein.

FIG. 4 is a block diagram illustrating an example data structure for a request to duplicate media, in accordance with embodiments herein.

FIG. 5 is an example repository of models from which a model can be selected for usage in duplicating media, in accordance with embodiments herein.

FIG. 6 is an illustrative process for reconfiguring the selected model and duplicating media, in accordance with embodiments herein.

FIG. 7 is a flow diagram illustrating a process for duplicating media, in accordance with embodiments herein.

FIG. 8 is a high-level block diagram illustrating an example artificial intelligence (AI) system, in accordance with one or more implementations.

FIG. 9 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Providing and ensuring reliable network connectivity is a consistent issue, especially as the number of interconnected devices and systems communicating over networks grows. Many integral services are reliant on devices connected to networks, such as in emergency response, where delays or disruptions can have life-threatening consequences. As wireless communication moves toward 6G, use cases such as MR, AR, VR, spatial audio, and the like require both transmittal of high volumes of content and ultra-low latency in communications to render high volumes of content to end users. Even as higher-frequency spectrums such as sub-terahertz (sub-THz) or THz are being developed to provide larger bandwidth, doing so causes additional issues.

In particular, one downside of using higher-frequency spectrums is that as frequency becomes higher, the available cell radius becomes smaller and smaller. Thus, using such high-frequency spectrums inevitably requires more cells to cover the same amount of area. Deploying a greater number of smaller cells at those frequencies would demand more resources and be more computationally expensive, as building and managing the cells would require more operators, more hardware, and more software for monitoring the cells. Furthermore, doing so would require a large transport capacity to overhaul traffic from the cells to the central office.

Thus, in order to provide such high volumes of content with low latency, content must be able to be transmitted using less bandwidth. Accordingly, a mechanism is desired that enables transmission of content, especially high-volume content such as media (e.g., audio, video, high-fidelity images), such as by using less bandwidth. In particular, systems and methods disclosed herein leverage the deterministic nature of some models in order to duplicate the same media across different devices. That is, rather than transmitting the media itself (e.g., pixel values, sample values, etc.), techniques are described herein to transmit data that can re-create media generated using models, such as generative models. For example, a user at a first device, such as a developer of an application at a mobile device, can first generate high-volume media such as a VR scene using an image generation model using prompts. Rather than transmitting the media itself, which would involve encoding video frames and compressing them, such as using various codecs, the user can simply store and transmit data that enables a VR device to re-create the VR scene using a model on the VR device. Doing so can significantly reduce the bandwidth being used, while still retaining the same information needed to re-create the image at other devices.

For example, the downstream device (e.g., VR device) can receive this data in the form of a request for duplicating media previously generated using a first model executing on a remote device. The downstream device can extract values for parameters that enable the downstream device to duplicate the media at the downstream device. For example, the parameters can include information such as the model used by the remote device to initially generate the image. The parameters can also include a seed value, prompts (e.g., both positive and negative prompts), or the like.

The downstream device can then identify the model, such as from a set of models available to the downstream device. The model can be a second instance of a same model used to generate the media in the initial occasion, or the model can be a similar model to the one used to generate the media in the initial occasion. The downstream device can configure the parameters of the model on its own device using a seed value, such that the model on the downstream device is in a same state as the model on the remote device previously used to generate the media in the first occasion. The prompt(s) can be input into the model to obtain the duplicated media. In some examples, the downstream device can generate one or more commands for rendering the media at the downstream device, e.g., such as for display to the user.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

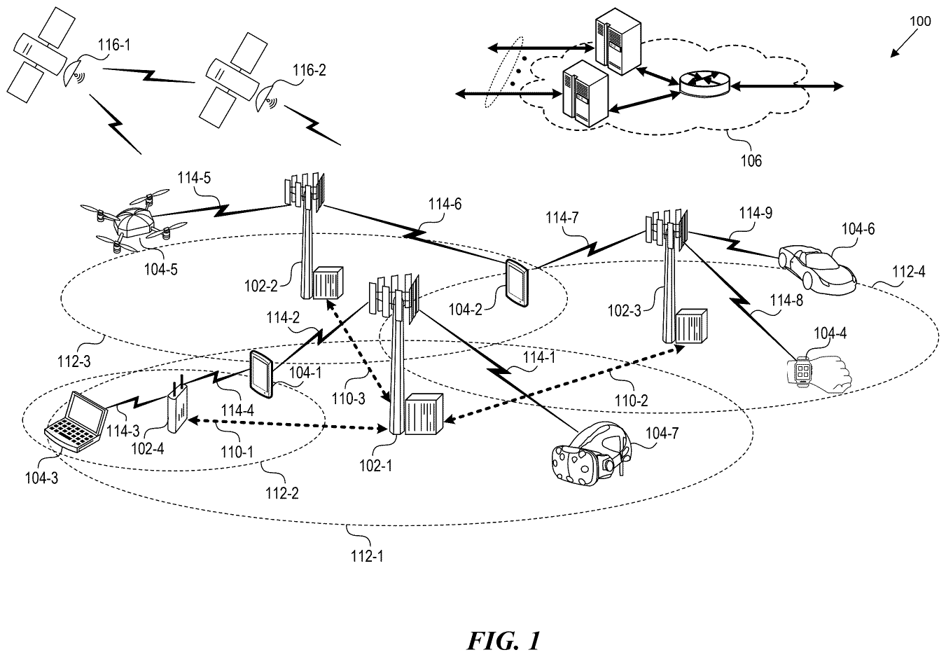

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an IEEE 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 gigahertz (GHz) or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 provides communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station as compared to a macro cell and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless AR/VR connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100, including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The DL transmissions can also be called forward link transmissions, while the UL transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support THz communications. This can support wireless applications that demand ultra-high quality of service (QoS) requirements and multi-terabits per second data transmission in the 6G and beyond era, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage.

### 5G Core Network Functions

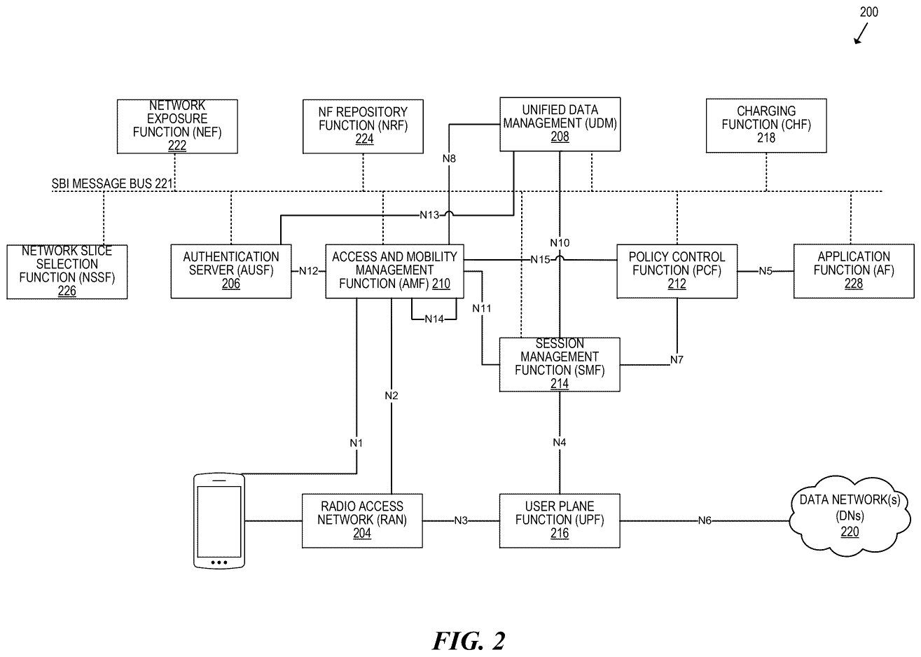

FIG. 2 is a block diagram that illustrates an architecture 200 including 5G core network functions (NFs) that can implement aspects of the present technology. A wireless device can access the 5G network through a NAN (e.g., gNB) of a RAN 204. The NFs include an Authentication Server Function (AUSF) 206, a Unified Data Management (UDM) 208, an Access and Mobility Management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service-Based Architecture (SBA) through a Service-Based Interface (SBI) 221 that uses Hypertext Transfer Protocol (HTTP)/2. The SBA can include a network Exposure Function (NEF) 222, a NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, service-level agreements, and includes the virtualized resources required to service the needs of a Mobile Virtual Network Operator (MVNO) or group of subscribers, including a dedicated UPF, SMF, and PCF. The wireless device 104 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more application functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of network functions once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

Although exemplary embodiments are described herein with reference to telecommunications and networks, the concepts of the present invention are not limited in application to such networks. It will be appreciated by those of skill in the art that the concepts of the present invention can be applied outside of telecommunications and networking, such as through a single device or a cluster of remote devices.

### Suitable Computing Environments

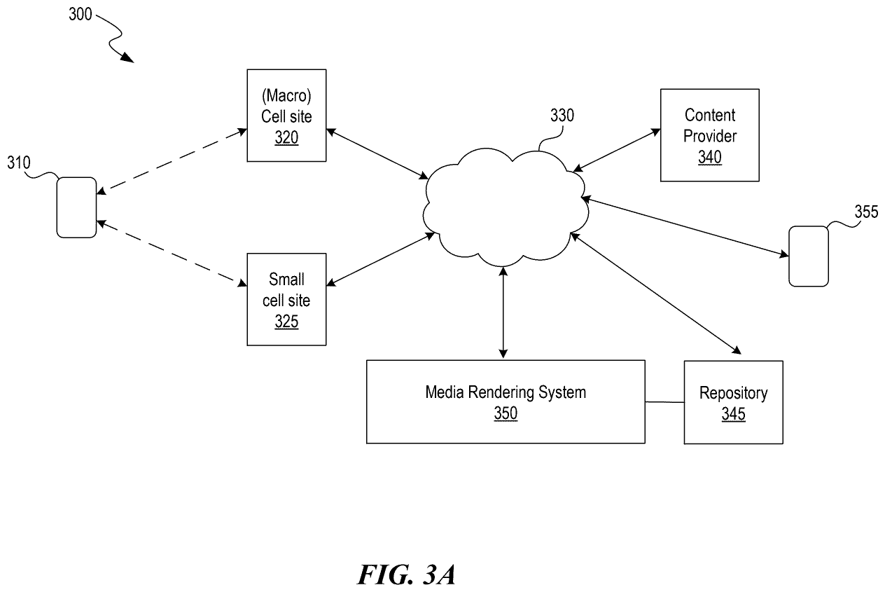

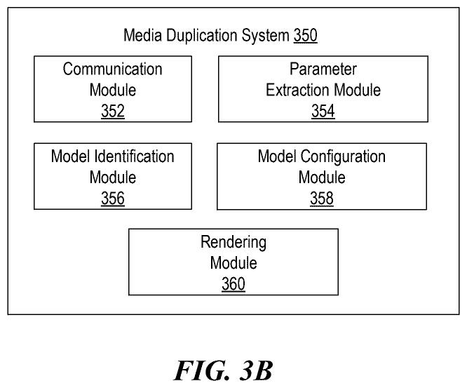

FIG. 3A is a block diagram illustrating a suitable computing environment for recreating previously generated media using a model, in accordance with embodiments herein, such as through replication, duplication, recreation, regeneration, e.g., or otherwise obtaining previously generated media at a different device. Although referenced herein as duplication or regeneration of media, it should be appreciated that the methods described herein may be used for replication, recreation, and/or the like. Furthermore, it may be appreciated that duplication as referred to herein can mean to regenerate media without knowledge of the previously generated media (e.g., without the data of the media itself such as pixel values or audio samples), but instead only with knowledge of the previously used parameters, such that duplication may not occur as a copy of the previously generated media, although the resulting media may be the same. As referred to herein, media can refer to any information that can be rendered for a user through a device. For example, media can include images, videos, audio, text, braille (e.g., in the context of a braille electronic reader (e-reader)), scents or other four-dimensional effects (e.g., wind), haptic feedback, and/or a combination. As described herein, the computing environment 300 of FIG. 3A can be used to duplicate media and, in some embodiments, can be further used in rendering the regenerated media for a user.

Computing environment 300 can include one or more remote device(s) 310, one or more cell sites 320 and 325, telecommunications network 330, content provider 340, cloud data repository 345, one or more other user devices 355, and media rendering system 350. The remote device(s) 310, such as mobile devices or UE associated with users (such as VR headsets, mobile phones (e.g., smartphones), tablet computers, laptops, and so on), IoT devices, vehicles (e.g., smart vehicles), devices with sensors, and so on, can be configured to receive and transmit data, stream media content, and/or perform other communications or receive services over a telecommunications network 330, which is accessed by the remote device 310 over one or more cell sites 320, 325. For example, the remote device 310 accesses a telecommunications network 330 via a cell site at a geographical location that includes the cell site in order to transmit and receive data (e.g., stream or upload multimedia content) from various entities, such as a content provider 340, a cloud data repository 345, and/or other user devices 355 on the telecommunications network 330 and via the cell site 320.

The cell sites can include macro cell sites 320, such as base stations, small cell sites 325, such as pico cells, micro cells, or femto cells, and/or other network access components or sites. The cell sites 320, 325 can store data associated with their operations, including data associated with the number and types of connected users, data associated with the provision and/or utilization of a spectrum, radio band, frequency channel, and so on, provided by the cell sites 320, 325, and so on.

According to some embodiments, computing environment 300 can be configured to duplicate media, such as media previously generated by a remote device. For example, FIG. 3A and the discussion herein provide a brief, general description of a suitable computing environment 300 in which the media rendering system 350 can be supported and implemented. According to some embodiments, the media rendering system 350 can be hosted or executed on the device or on the network. For example, media duplication may occur at an end user device (e.g., for the ultimate recipient of the media), such as a mobile phone of the user. Doing so enables bandwidth in RAN, core, transport network to be saved and also resolves latency issues, especially in 6G. Alternatively, or additionally, such as if a user device does not have the capability to regenerate the content on the device, the media rendering system 350 may be hosted instead on a network node such as gNB using AI-RAN and may simply recreate the image to transmit to the end user device.

Although not required, aspects of the media rendering system 350 are described in the general context of computer-executable instructions, such as routines executed by a computer, e.g., a mobile device, a server computer, or a personal computer (PC). The system can be practiced with other communications, data processing, or computer system configurations, including: Internet appliances, handheld devices (including tablet computers and/or personal digital assistants (PDAs)), IoT devices, all manner of cellular or mobile phones, multi-processor systems, microprocessor-based or programmable consumer electronics, set-top boxes, network PCs, mini-computers, mainframe computers, and the like. Indeed, the terms “computer,” “host” and “host computer,” and “mobile device” and “handset” are generally used interchangeably herein and refer to any of the above devices and systems as well as any data processor.

Aspects of the system can be embodied in a special-purpose computing device or data processor that is specifically programmed, configured, or constructed to perform one or more of the computer-executable instructions explained in detail herein. Aspects of the system can also be practiced in distributed computing environments where tasks or modules are performed by remote processing devices, which are linked through a communications network, such as a Local Area Network (LAN), Wide Area Network (WAN), or the Internet. In a distributed computing environment, program modules can be located in both local and remote memory storage devices.

Aspects of the system can be stored or distributed on computer-readable media (e.g., physical and/or tangible non-transitory, computer-readable storage media), including magnetically or optically readable computer discs, hard-wired or preprogrammed chips (e.g., Electrically Erasable Programmable Read-only Memory (EEPROM) semiconductor chips), nanotechnology memory, or other data storage media. Indeed, computer-implemented instructions, data structures, screen displays, and other data under aspects of the system can be distributed over the Internet or over other networks (including wireless networks), distributed on a propagated signal on a propagation medium (e.g., an electromagnetic wave(s), a sound wave, etc.) over a period of time, or provided on any analog or digital network (packet switched, circuit switched, or other scheme). Portions of the system reside on a server computer while corresponding portions reside on a client computer, such as a mobile or portable device, and thus, while certain hardware platforms are described herein, aspects of the system are equally applicable to nodes on a network. In alternative implementations, the mobile device or portable device can represent the server portion, while the server can represent the client portion.

In some implementations, the remote device 310 and/or the cell sites 320, 325 can include network communication components that enable the devices to communicate with remote servers or other portable electronic devices by transmitting and receiving wireless signals using a licensed, semi-licensed, or unlicensed spectrum over a communications network, such as the telecommunications network 330. In some cases, the telecommunications network 330 can comprise multiple networks, even multiple heterogeneous networks, such as one or more border networks, voice networks, broadband networks, service provider networks, Internet Service Provider (ISP) networks, and/or Public Switched Telephone Networks (PSTNs) interconnected via gateways operable to facilitate communications between and among the various networks. The telecommunications network 330 can also include third-party communications networks such as a GSM mobile communications network, a CDMA/TDMA mobile communications network, a 3G/4G mobile communications network (e.g., GPRS/EGPRS, EDGE, UMTS, or LTE network), a 5G mobile communications network, Wi-Fi, or other communications networks. Thus, the user device is configured to operate and switch among multiple frequency bands for receiving and/or transmitting data.

Further details regarding the operation and implementation of the media rendering system 350 will now be described.

### Examples of Systems for Media Rendering

FIG. 3B is a block diagram illustrating the components of an exemplary media rendering system. The media rendering system 350 can include functional modules that are implemented with a combination of software (e.g., executable instructions or computer code) and hardware (e.g., at least a memory and processor). Accordingly, as used herein, in some examples a module is a processor-implemented module or set of code and represents a computing device having a processor that is at least temporarily configured and/or programmed by executable instructions stored in memory to perform one or more of the specific functions described herein. For example, the media rendering system 350 includes a communication module 352, a parameter extraction module 354, a model identification module 356, a model configuration module 358, and a rendering module 360, each of which is discussed separately below.

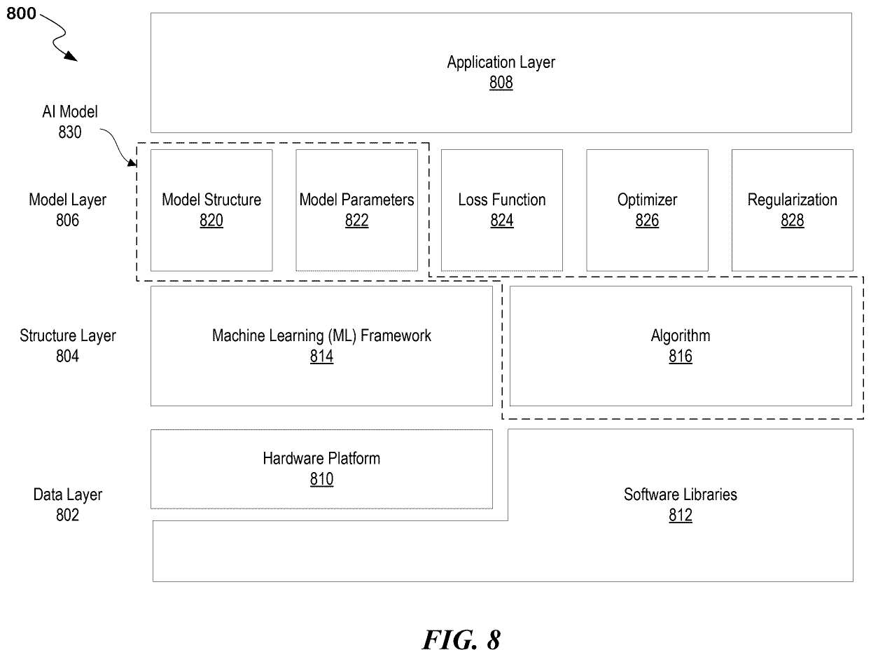

As described herein, the media rendering system 350 can be used to duplicate media previously generated at a remote device. For example, a user at the remote device 310 can initially generate media using a model available to the remote device 310. The model can be executed locally on the remote device 310 or on a platform available to the remote device. In particular, the models can be deployed on a cloud platform environment, such as Amazon Web Services (AWS), Microsoft Azure, and Google Cloud Platform (GCP), or on a base station corresponding to the remote device 310. The model can be an AI model such as one including a neural network, a large language model, or a small language model. In some examples, the model can include a generative model such as a speech synthesis model, music generation model, video generation model, image generation model, diffusion model, or foundation model. In some embodiments, a combination of models can be utilized as well. Exemplary models are described in relation to FIG. 8.

The user at the remote device 310 can use a model at an initial state, such as one configured using a seed value used in the first model at the remote device 310. The seed value can include any value (e.g., numerical, alphanumeric, etc.) that can be used to control the randomness in the output of the model. Using a same seed value at different instances of a same model can ensure that the output can be reproduced across the instances without variance. Transmitting the seed value can thus ensure that the same media is output later (e.g., at media rendering system 350) as is generated on a remote device 310. The user can input, into the initialized session at the remote device 310, prompts such as “Generate an image of a cow in a field.” As described herein, a prompt can include any input to a model (e.g., functions, questions, code snippets, or complex instructions) in the form of text (e.g., natural language text).

The user can continually input prompts sequentially within the session to edit the output media. For example, the user can input prompts such as “The field should have grass,” “Make the field have flowers,” and “more flowers” sequentially, to continually edit the output image. The user can also include negative prompts such as “Take out 1 cow.” A negative prompt, as referred to herein, can include instructions given to a model to exclude specific elements, themes, concepts, or styles during content creation. In the provided example, the user can wish to remove a single cow from the image output as a result of the prompt preceding the negative prompt.

The prompts can be compiled into a text file or data structure that can be transmitted downstream. In some embodiments, the inputs can be obtained via a user interface (UI) on the remote device 310. For example, the remote device 310 can include input mechanisms such as for text via keyboard and mouse, touchscreen, or through audio input. Alternatively or additionally, a user at the remote device 310 can use gestures or a stylus to input prompts as well. According to some embodiments, the prompt(s) can include one or more images, video, or audio, e.g., to which the user would like modification. The image, video, or audio can be obtained using sensors or platforms on the remote device 310 or on a different device, such as using a camera, microphone, or photo/video editing platform.

When the user then wishes to transmit the media to a different user device, such as for presentation (e.g., viewing, listening, feeling, or smelling) to others, the remote device 310 can then generate and transmit a request to duplicate the media at a recipient device. The request can indicate, for example, what model to use (or a list of prioritized models to use if the same model is unavailable), the prompts to input, and how to initialize the same state as was previously used to generate the media. In some examples, the remote device 310 can directly transmit the request to the recipient device. Alternatively or additionally, the user at the remote device 310 can be an operator who uploads the request data via the remote device 310 to the cloud (e.g., as part of a social media post, or a mobile application deployed on the cloud) and the request data can be accessed (e.g., downloaded) by a device of anyone who has access to the uploaded data (e.g., connected users on a social media platform, subscribers to an application). When the user attempts to transmit the media, the remote device 310 can automatically generate the request by inserting the needed parameters and transmit the request to the identified recipient(s). As described herein, the recipient user device can include or otherwise be communicatively coupled to technical components enabled to present the media to the user. For example, the technical components can include a VR, XR, or AR headset, an audio headset, a diffuser, and/or the like.

According to some embodiments, the user can also modify the media prior to transmission such as through a method different from additional prompts. For example, the user can mark up an image or overlay a sound onto the media after generation of the media. The user can desire to transmit these modifications to a recipient as well. In this case, the request can further include one or more masks indicative of edits made to the media at the remote device 310. For example, the one or more masks can include at least one of a spectrogram mask, time-domain mask, frequency mask, or alpha mask.

Additionally or alternatively, the remote device 310 can encrypt the request or a portion of the request (e.g., the prompts) in order to preserve security. In this case, the remote device 310 can encrypt the request, or a portion thereof, using the public key of an intended recipient, and the intended recipient device can decrypt the request using the private key of the device.

The identified recipient(s) can each include a media rendering system 350 configured to duplicate the media using the request data.

### Communication Module

The communication module 352 of the media rendering system 350 can include software and/or hardware components allowing for the transmission and/or receipt of information between two or more devices. The communication module 352 can include a wireless communication module, such as a cellular radio or Wi-Fi antenna, to allow for communication over wireless networks and/or can additionally or alternatively include a network card (e.g., a wireless network card and/or a wired network card) that is associated with software to drive the card.

The communication module 352 is configured and/or programmed (e.g., via the above-mentioned techniques) to interface between a device (e.g., remote device(s) 310, one or more other user devices 355), cell sites (e.g., cell sites 320, 325), a content provider (e.g., content provider 340), and a cloud data repository (e.g., cloud data repository 345) such as via a network (e.g., telecommunications network 330) to receive and transmit data such as requests from devices and/or model data (e.g., model parameters that can be used to execute a model) such as from a centralized data repository. When the communication module 352 receives data, the module can pass on relevant portions of the data to different modules of the media rendering system 350. The communication module 352 can also be configured to generate and transmit notifications such as of successful duplication. Alternatively or additionally, the communication module 352 can be used to generate and transmit instructions for causing rendering of the regenerated media to a user.

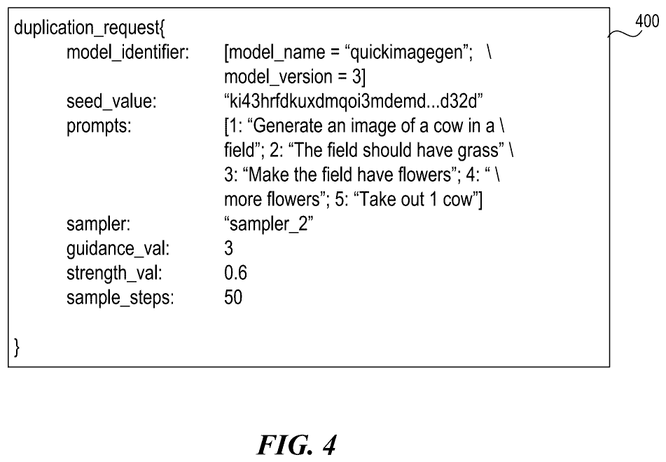

As described herein, the communication module 352 of the media rendering system 350 can receive, access, or otherwise obtain, e.g., such as from one or more users at a remote device 310 or other user devices 355, a request for duplicating media previously generated on a remote device (e.g., remote device 310) using a first model executing on a remote device at the media rendering system 350. For example, FIG. 4 includes an exemplary request 400 for duplicating media that can be received at the communication module 352, such as for duplicating media using a diffusion model. Although specific parameters are shown in the example of FIG. 4, it should be appreciated that any combination of the illustrated parameters can be used. Furthermore, specific parameters should with respect to FIG. 4 can be used for diffusion models, and different types of models may utilize different sets or types of parameters. In the example of FIG. 4, the request 400 includes parameters such as a model identifier and model-specific parameters.

As referred to herein, the model identifier can include one or more values that, in combination, are suitable for uniquely identifying a model or instances of a model at the system. The model identifier can include one or more of a numeric value, string value, or alphanumeric value. For example, the model identifier can include a model name. In some examples, the model identifier can further include a version number, which can be used in cases where a model has different versions released and deployed at the same time across different devices. In the example of FIG. 4, the model identifier can be identified as a value for the field “model_identifier.” For example, the request 400 includes “[model_name=‘quickimagegen’; model_version=3]” which identifies the name of the model as “quickimagegen” and the model version as 3.

As described herein, the parameters can also include model-specific parameters. In some examples, the model-specific parameters can vary between different models. For example, the model “quickimagegen” can include model-specific parameters such as those shown in FIG. 4, including a seed value, prompt(s) (e.g., positive and negative prompts), sampler algorithm(s), guidance scale value(s), strength value(s), and the number of sample steps; however, other models can require or optionally include other model-specific parameters or exclude any combination of the listed parameters.

As in the example of FIG. 4, the parameters can also include an identifier for a sampler algorithm. The sampler algorithm shown in the request 400 is identified using a string value “sampler_2”; however, as described herein with respect to the model identifier, any combination of any number of values, including numeric, string, or alphanumeric, can be used to uniquely identify the sampler algorithm to be used. As described herein, a sampler algorithm can include algorithms used to generate media outputs by selecting samples from a learned probability distribution. These algorithms can be used to control the quality, diversity, and/or coherence of generated media content.

The guidance scale value, shown as “guidance_val” in FIG. 4, can be a weighting factor that influences how strongly a model adheres to a given conditioning signal (e.g., a prompt) during the generation process. For example, the guidance scale value can modify a loss function or the sampling process by adjusting the strength of the conditioned probability distribution relative to an unconditioned (random) distribution. In one example, a low guidance scale value, such as a value from 1 to 3, can lead to a more loosely related or abstract output from the prompt(s) given. A medium guidance scale value, such as a value from 4 to 7, can lead to a more balanced output that is between a loose relation and strict adherence to the prompt(s), while a high guidance scale value, such as a value of 8 or above, can enforce strict adherence to the prompt(s).

The strength value, shown as “strength_val” in FIG. 4, can be a parameter that controls how much transformation is applied to an input during the generation process. For example, the strength value can influence the number of denoising steps applied, and thus affecting how much input noise is retained. For example, a strength value can be a decimal (e.g., float) value between 0 and 1. A lower strength value (e.g., 0-0.4) can be indicative of less transformation applied to the input, while a higher strength value (e.g., 0.7-1) can indicate that more transformation is applied.

The sample steps value, shown as “sample_steps” in FIG. 4, can refer to the number of iterative denoising steps used during the generation process. For example, fewer steps (e.g., 10-20 steps) can result in faster generation but can produce artifacts or blurry results, while a high number of steps (e.g., 250-1000) can produce very high-quality and detailed outputs.

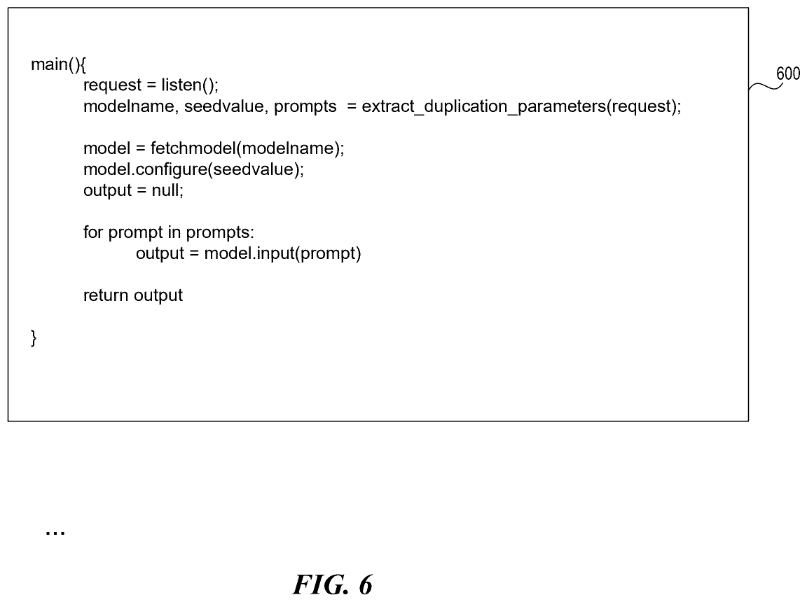

The communication module 352 can be monitoring for incoming requests from various external sources. For example, as described herein, the communication module 352 can obtain the requests from an external source such as the remote device 310, a remote server, and/or the like. For example, FIG. 6 illustrates a process 600 through which media can be regenerated. The communication module can be configured to listen for data (e.g., “listen()”) and store the value in a request data structure (e.g., “request”). Once the communication module 352 obtains the request, the communication module 352 can pass the request data, or a pointer to the data in memory, to the parameter extraction module 354. As described herein, communication module 352 may also be used to transmit a notification of successful duplication, or indicating failure to duplicate successfully.

### Parameter Extraction Module

The parameter extraction module 354 can be configured to extract the above-described parameters from the request (e.g., request 400). As described herein, in the example where the request, or a portion thereof, is encrypted such as for security of the underlying prompts or seed value, the parameter extraction module 354 can decrypt the request, or a portion thereof, as well. For example, in the case where the request has been encrypted using a public key of the recipient device (e.g., the device on which the media rendering system 350 is hosted), the parameter extraction module 354 can use the private key of the recipient device to decrypt the request data, or a portion thereof.

The parameter extraction module 354 can first extract the model identifier and pass the model identifier, or a pointer to the data in memory, to the model identification module 356. The model identification module 356 can be configured to identify a second model corresponding to the first model used at the remote device 310 to previously generate the media. In some examples, both the media rendering system 350 and the remote device 310 can have access to instances of the same model. For example, the remote device 310 can have previously used a first instance of a model to generate the media, and the media rendering system 350 can have access to a second instance of the same model to duplicate the media. In this case, the parameter extraction module 354 can simply extract the parameters and pass them, or a pointer to the data in memory, without further need for modification.

According to some embodiments, the model identification module 356 can be unable to find an instance of the same model used by the remote device 310. In this case, the model identification module 356 can identify a model that is similar to (e.g., based on a similarity metric) the first model used by the remote device 310 to previously generate the media. In this case, the parameter extraction model 354 can transform some or all of the model-specific parameters so that they are compatible with the model identified by the model identification module 356. In some examples, the parameters can be transformed using a schema, such as one developed by an operator. In other examples, some or all of the parameters can be transformed using a machine learning model configured to transform parameters based on model type.

In one example, the model can be a same model but having a different version. For example, the system can have access to only a previous version of the model that used fewer parameters. In this case, the model-specific parameters can be used as-is, but the remaining parameters can be left out. The media rendering system 350 can transmit a notification to the user that the model version or the model itself is different, so the resulting output can vary from the original media.

For example, FIG. 6 illustrates a process 600 through which media can be regenerated. The parameter extraction module can be configured to perform an extraction subroutine or function on the received request (e.g., “extract_duplication_parameters(request)”) and store each parameter data in its corresponding variable (e.g., “modelname, seedvalue, prompts”). Once the parameter extraction module 354 obtains the parameters, the parameter extraction module 354 can pass the parameter data, or a pointer to the data in memory, to the model configuration module 358.

### Model Identification Module

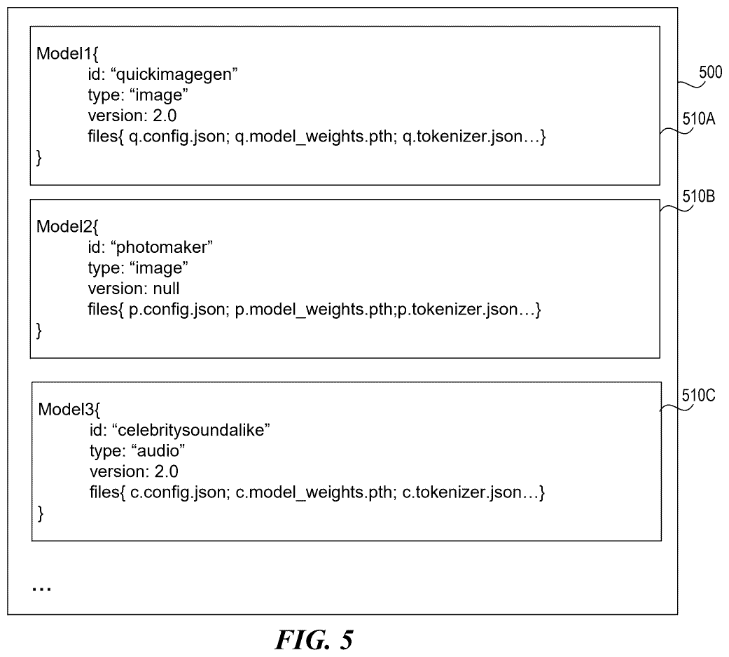

As described herein, the parameter extraction module 354 can pass the model identifier, or a pointer to the data in memory, to the model identification module 356. As described herein, the model identification module 356 can be configured to identify a second model corresponding to the first model used at the remote device 310 to previously generate the media. The model identification module 356 can access a local or remote repository 345 storing the model's architecture and parameters for a plurality of different models. For example, FIG. 5 is an example of various models stored in a repository 500 for illustrating embodiments of techniques described here. The models used may include different names and identifiers.

The repository 500 can include data structures such as for model data 510A, model data 510B, and model data 510C. The model data can include the model identifier (e.g., model name and version) as well as other data such as a type of media generated as output (e.g., “type”) and where the files can be found (e.g., filenames, pointers, etc.). In the example of FIG. 5, the model data 510A shows a model having name “quickimagegen” and version “2.0.” The model data also includes file names “q.config.json,” “q.model_weights.pth,” and “q.tokenizer.json” among those not shown in the example of FIG. 5.

The model identification module 356 can first attempt to identify whether both the media rendering system 350 and the remote device 310 can have access to instances of the same model. That is, as described herein, the remote device 310 can have previously used a first instance of a model to generate the media, and the media rendering system 350 can have access to a second instance of the same model to duplicate the media. The model identification module 356 can do so by generating a query with the model identifier. In this case, the model identification module 356 can simply identify the model using the model identifier. In the example of FIG. 4 and FIG. 5, the model can be identified using the model name and version number.

If the model identification module 356 is unable to find an instance of the same model used by the remote device 310, the model identification module 356 can trigger a process to identify a model that is similar to the first model used by the remote device 310 to previously generate the media. For example, if the search query to the repository returned null, the model identification module 356 can trigger a process to identify a model that is similar to the first model. In some examples, the model identification module 356 can generate a similarity metric based on a plurality of factors and select the model having the highest similarity metric value. The similarity metric can be calculated based on the type of media the model generates, whether the entities that deploys the models are the same, whether the model is the same but a different version is available, and/or the like.

In some instances, the request can indicate several alternative models or versions that a system can use if the same model is unavailable. For example, a user at the remote device 310, prior to sending the request to the recipient device (e.g., the media rendering system 350), can select several options for models that can be used if the model the remote device 310 used is unavailable. In some examples, the user can rank or prioritize certain models that can be used and/or indicate models that should not be used to duplicate the media.

In the example of FIG. 5, the model identification module 356 can initially attempt a search using the model name “quickimagegen” and version 3 and optionally media type, however, the search to repository 500 can return a null value since there is no model available to the system having the same criteria. Instead, the model identification module 356 can then trigger the process to identify a similar model, such as by first seeing if other models are available, or by calculating a similarity metric. In some examples, the process can include checking the ranked list of alternative models sequentially and identifying whether a listed model is available in the repository. In particular, the system can generate search queries using the model identifiers from the list. In this example, the repository 500 stores a model by the same name “quickimagegen” but having a different value for the version, e.g., “2.0.”

In the case that the repository is remote, upon identifying a model, the repository can transmit the needed files in order to execute the model locally on the system. Alternatively or additionally, if the repository is local, the repository can simply pass a pointer to the model data, or a portion thereof, to the model identification module 356, which can then pass the model data, or a portion thereof, to the model configuration module 358. For example, FIG. 6 illustrates a process 600 through which media can be regenerated. The model identification module 356 can be configured to perform a subroutine or function to fetch the model by generating a query using the model identifier (e.g., “fetchmodel(modelname)”).

According to some embodiments, the model rendering system may store some models locally while others are not local. In this case, the system may search or query the central model repository 345 in order to obtain the right model.

### Model Configuration Module

As described herein, the model identification module 356 and parameter extraction module 354 can pass model data and model-specific parameters, respectively, to the model configuration module 358. The model configuration module 358 can initialize the model parameters of the second model using parameters extracted, or transformed, from the request. In particular, the model configuration module 358 can initialize the model parameters using the seed value to correspond the previous session of a model at the remote device 310 during which the media was previously generated. That is, by using the same seed value as was previously used by the remote device 310, the system can re-create the same state and ensure that the same media is generated at the media rendering system 350 as was previously generated by the remote device 310

The model identification module 356 can also apply the guidance scale value, the strength value, the number of sample steps, and the sampler algorithm extracted, or transformed, from the request. As described herein with respect to the models, if the same sampler algorithm identified in the request cannot be found (e.g., at a local or remote repository), the system can identify another sampler algorithm that is determined to be similar, such as using a similarity metric. Alternatively or additionally, the request itself can come with identifiers for one or more alternative sampler algorithms that can be used. In some examples, if the same sampler algorithm or the alternative sampler algorithms are not available, the media rendering system 350 can transmit a notification to the recipient user or the transmitting user (e.g., user at remote device 310) that the media was not regenerated using the same sampler algorithm

For example, as described herein, FIG. 6 illustrates a process 600 through which media can be regenerated. The model configuration module can be used to perform a subroutine or function to configure the model using the obtained model and extracted (or transformed) model parameters (e.g., “model.configure(seedvalue)”).

The model configuration module 358 can input the one or more prompts into the model to regenerated media. For example, as can be seen in FIG. 6, the rendering module 360 can be configured to sequentially input the prompts, including any negative prompts, into the initialized session of the configured model in order to duplicate the media. The example shown in process 600 shows a loop that iterates through each prompt and inputs each into the model, e.g., “for prompt in prompts: output=model.input(prompt).” The model configuration module 358 can then pass the output, or a pointer to the data in memory, to the rendering module 360, which can then be used to render the media for presentation to a user.

### Rendering Module

The rendering module 360 can then be used to generate one or more commands for causing the regenerated media to be rendered at the user device. For example, if the media is an image, the rendering module 360 can generate commands to display the image to the user, such as via a screen. In the example where the media is audio, the rendering module 360 can generate commands such as to transmit the audio for playback on a speaker or headphone device.

As described herein, the request can additionally include one or more masks including the user's edit to the previously generated media at the remote device 310. In this example, the rendering module 360 can apply the masks to the regenerated media prior to generating commands for rendering the media for presentation to the user. In this case, when the media rendering system 350 generates commands for rendering the media, the rendering module 360 can generate commands to overlay the mask over the regenerated media.

According to some embodiments, a user who views, or otherwise receives, the rendered regenerated media can wish to perform one or more modifications to the media. In one example, the user can input prompts, such as using input methods described herein. The media rendering system 350 can receive the one or more subsequent prompts for modifying the regenerated media and input, into the model, the prompt(s) to obtain a modified version of the regenerated media. The system can then generate one or more commands for causing the modified version of the regenerated media to be rendered at the user device.

According to some embodiments, prior to rendering the media, the rendering module 360 can first perform a check to ensure the media has been regenerated correctly. For example, the request can further include a checksum value or other values that can be used to check whether the regenerated media matches the previously generated media. When the remote device 310 generates the media, the device can include one or more pixel values at a set location, a total sum of pixel values, a maximum pixel value, or an equivalent value for sound or video. The device can include this data as part of the request so that when the media rendering system 350 duplicates the media, the media rendering system 350 can perform a check to ensure that the values match. In one embodiment, if the values do not match, the system can transmit a notification of failure. In another embodiment, the system can simply check to confirm that the difference between the values is within a user or operator set threshold difference value. In this embodiment, if the difference exceeds the threshold difference value, the system can transmit a notification of failure (e.g., via communication module 352).

Alternatively or additionally, upon performing a successful check (e.g., where the previously generated media matches the regenerated media) or upon obtaining an output from the model, the system can transmit a notification that the media was regenerated successfully to the remote device 310.

### Flow Diagram

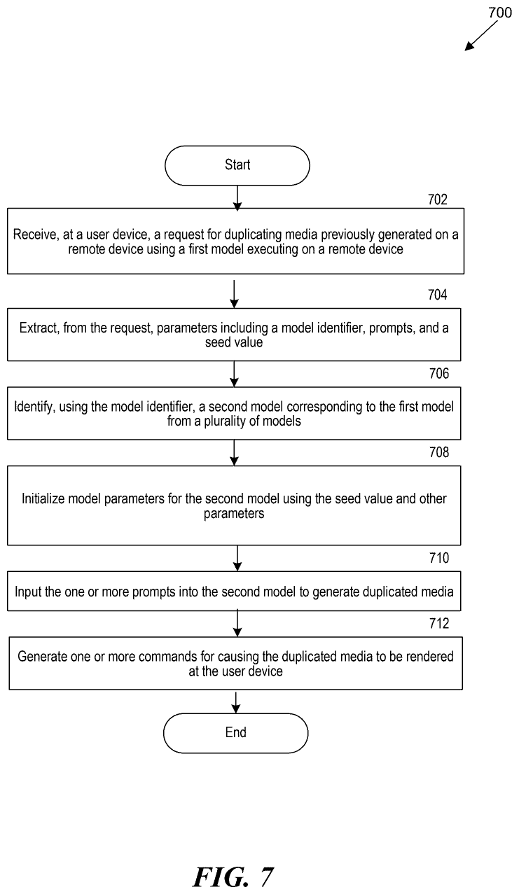

FIG. 7 is a flow diagram illustrating a process 700 for duplicating media, in accordance with embodiments herein. In particular, the process 700 can be used to duplicate media that was previously generated such as on a remote device using one or more models. The process 700 begins at block 702 where a system (e.g., such as media rendering system 350) receives, at a user device, a request for duplicating media previously generated on a remote device using a first model executing on a remote device (as discussed above in reference to the communication module 352).

At block 704, the process 700 includes extracting, from the request, parameters including a model identifier, prompts, and a seed value (as discussed above in reference to the parameter extraction module 354). The process 700 then proceeds to block 706, where the system identifies, using the model identifier, a second model corresponding to the first model from a plurality of models (as discussed above in reference to the model identification module 356). At block 708, the process 700 initializes model parameters for the second model using the seed value and other parameters. At block 710, the system can input the one or more prompts into the second model to generate regenerated media. The process 700 then proceeds to block 712, where the system generates one or more commands for causing the regenerated media to be rendered at the user device (as discussed above in reference to the rendering module 360). According to some embodiments, the system can further transmit a notification that the media was regenerated successfully or, alternatively or additionally, can edit the regenerated media.

### AI System

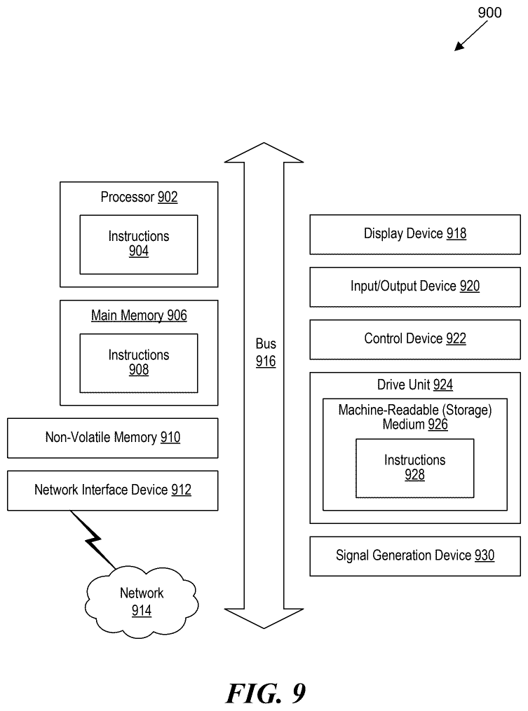

FIG. 8 is a block diagram illustrating an example AI system 800, in accordance with one or more implementations of this disclosure. The AI system 800 is implemented using components of the example computer system 900 illustrated and described in more detail with reference to FIG. 9. For example, the AI system 800 can be implemented using the processor 902 and instructions 908 programmed in the main memory 906 illustrated and described in more detail with reference to FIG. 9. Likewise, implementations of the AI system 800 can include different and/or additional components or be connected in different ways.

As shown, the AI system 800 can include a set of layers, which conceptually organize elements within an example network topology for the AI system's architecture to implement a particular AI model 830. Generally, an AI model 830 is a computer-executable program implemented by the AI system 800 that analyzes data to make predictions. Information can pass through each layer of the AI system 800 to generate outputs for the AI model 830. The layers can include a data layer 802, a structure layer 804, a model layer 806, and an application layer 808. The algorithm 816 of the structure layer 804 and the model structure 820 and model parameters 822 of the model layer 806 together form the example AI model 830. The loss function engine 824, optimizer 826, and regularization engine 828 work to refine and optimize the AI model 830, and the data layer 802 provides resources and support for application of the AI model 830 by the application layer 808.

The data layer 802 acts as the foundation of the AI system 800 by preparing data for the AI model 830. As shown, the data layer 802 can include two sub-layers: a hardware platform 810 and one or more software libraries 812. The hardware platform 810 can be designed to perform operations for the AI model 830 and can include computing resources for storage, memory, logic, and networking, such as the resources described in relation to FIG. 9. The hardware platform 810 can process amounts of data using one or more servers. The servers can perform backend operations such as matrix calculations, parallel calculations, machine learning (ML) training, and the like. Examples of servers used by the hardware platform 810 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but can be used for AI applications due to their vast computing and memory resources. GPUs use a parallel structure that generally makes their processing more efficient than that of CPUs. In some instances, the hardware platform 810 can include Infrastructure as a Service (IaaS) resources, which are computing resources (e.g., servers, memory, etc.) offered by a cloud services provider. The hardware platform 810 can also include computer memory for storing data about the AI model 830, application of the AI model 830, and training data for the AI model 830. The computer memory can be a form of random-access memory (RAM), such as dynamic RAM, static RAM, and non-volatile RAM.

The software libraries 812 can be thought of as suites of data and programming code, including executables, used to control the computing resources of the hardware platform 810. The programming code can include low-level primitives (e.g., fundamental language elements) that form the foundation of one or more low-level programming languages, such that servers of the hardware platform 810 can use the low-level primitives to carry out specific operations. The low-level programming languages do not require much, if any, abstraction from a computing resource's instruction set architecture, allowing them to run quickly with a small memory footprint. Examples of software libraries 812 that can be included in the AI system 800 include INTEL MATH KERNEL LIBRARY, NVIDIA CuDNN, EIGEN, and OPEN BLAS.

The structure layer 804 can include a machine learning (ML) framework 814 and an algorithm 816. The ML framework 814 can be thought of as an interface, library, or tool that allows users to build and deploy the AI model 830. The ML framework 814 can include an open-source library, an application programming interface (API), a gradient-boosting library, an ensemble method, and/or a deep learning toolkit that work with the layers of the AI system 800 to facilitate development of the AI model 830. For example, the ML framework 814 can distribute processes for application or training of the AI model 830 across multiple resources in the hardware platform 810. The ML framework 814 can also include a set of pre-built components that have the functionality to implement and train the AI model 830 and allow users to use pre-built functions and classes to construct and train the AI model 830. Thus, the ML framework 814 can be used to facilitate data engineering, development, hyperparameter tuning, testing, and training for the AI model 830.

Examples of ML frameworks 814 or libraries that can be used in the AI system 800 include TensorFlow, PyTorch, Scikit-Learn, Keras, and Cafffe. Random Forest is a machine learning algorithm that can be used within the ML frameworks 814. LightGBM is a gradient-boosting framework/algorithm (an ML technique) that can be used. Other techniques/algorithms that can be used are XGBoost, CatBoost, etc. AWS is a cloud service provider that offers various machine learning services and tools (e.g., Sage Maker) that can be used for platform building, training, and deploying ML models.

In some implementations, the ML framework 814 performs deep learning (also known as deep structured learning or hierarchical learning) directly on the input data to learn data representations, as opposed to using task-specific algorithms. In deep learning, no explicit feature extraction is performed; the features of a feature vector are implicitly extracted by the AI system 800. For example, the ML framework 814 can use a cascade of multiple layers of nonlinear processing units for implicit feature extraction and transformation. Each successive layer uses the output from the previous layer as input. The AI model 830 can thus learn in supervised (e.g., classification) and/or unsupervised (e.g., pattern analysis) modes. The AI model 830 can learn multiple levels of representations that correspond to different levels of abstraction, wherein the different levels form a hierarchy of concepts. In this manner, the AI model 830 can be configured to differentiate features of interest from background features.

The algorithm 816 can be an organized set of computer-executable operations used to generate output data from a set of input data and can be described using pseudocode. The algorithm 816 can include complex code that allows the computing resources to learn from new input data and create new/modified outputs based on what was learned. In some implementations, the algorithm 816 can build the AI model 830 through being trained while running computing resources of the hardware platform 810. This training allows the algorithm 816 to make predictions or decisions without being explicitly programmed to do so. Once trained, the algorithm 816 can run at the computing resources as part of the AI model 830 to make predictions or decisions, improve computing resource performance, or perform tasks. The algorithm 816 can be trained using supervised learning, unsupervised learning, semi-supervised learning, and/or reinforcement learning.

Using supervised learning, the algorithm 816 can be trained to learn patterns (e.g., map input data to output data) based on labeled training data. The training data can be labeled by an external user or operator. For instance, a user can collect a set of training data, such as by capturing user device performance metrics, device data, network data, historical communication sessions, and the like. The user can label the training data based on one or more classes and trains the AI model 830 by inputting the training data to the algorithm 816. The algorithm 816 determines how to label the new data based on the labeled training data. The user can facilitate collection, labeling, and/or input via the ML framework 814. In some instances, the user can convert the training data to a set of feature vectors for input to the algorithm 816. Once trained, the user can test the algorithm 816 on new data to determine whether the algorithm 816 is predicting accurate labels for the new data. For example, the user can use cross-validation methods to test the accuracy of the algorithm 816 and retrain the algorithm 816 on new training data if the results of the cross-validation are below an accuracy threshold.

Supervised learning can involve classification and/or regression. Classification techniques involve teaching the algorithm 816 to identify a category of new observations based on training data and are used when input data for the algorithm 816 is discrete. Said differently, when learning through classification techniques, the algorithm 816 receives training data labeled with categories (e.g., classes) and determines how features observed in the training data relate to the categories. Once trained, the algorithm 816 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 816 is continuous. Regression techniques can be used to train the algorithm 816 to predict or forecast relationships between variables. To train the algorithm 816 using regression techniques, a user can select a regression method for estimating the parameters of the model. The user collects and labels training data that is input to the algorithm 816 such that the algorithm 816 is trained to understand the relationship between data features and the dependent variable(s). Once trained, the algorithm 816 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill in missing data for machine learning-based pre-processing operations.

Under unsupervised learning, the algorithm 816 learns patterns from unlabeled training data. In particular, the algorithm 816 is trained to learn hidden patterns and insights of input data, which can be used for data exploration or for generating new data. Here, the algorithm 816 does not have a predefined output, unlike the labels output when the algorithm 816 is trained using supervised learning. Another way unsupervised learning is used to train the algorithm 816 to find an underlying structure of a set of data is by grouping the data according to similarities and representing that set of data in a compressed format. The network 100 disclosed herein with reference to FIG. 1 can use unsupervised learning to identify patterns in data received.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has fewer or no similarities to another group. Examples of clustering techniques include density-based methods, hierarchical-based methods, partitioning methods, and grid-based methods. In one example, the algorithm 816 can be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 816 can be trained to be an Isolation Forest, local outlier factor (LOF) algorithm, or k-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that can be used by the algorithm 816 include factor analysis, item response theory, latent profile analysis, and latent class analysis.

In some implementations, the AI system 800 trains the algorithm 816 of the AI model 830, based on the training data, to correlate the feature vector to expected outputs in the training data. As part of the training of the AI model 830, the AI system 800 forms a training set of features and training labels by identifying a positive training set of features that have been determined to have a desired property in question, and, in some implementations, forms a negative training set of features that lack the property in question. The AI system 800 applies the ML framework 814 to train the AI model 830, which, when applied to the feature vector, outputs indications of whether the feature vector has an associated desired property or properties, such as a probability that the feature vector has a particular Boolean property, or an estimated value of a scalar property. The AI system 800 can further apply dimensionality reduction (e.g., via linear discriminant analysis (LDA), principal component analysis (PCA), or the like) to reduce the amount of data in the feature vector to a smaller, more representative set of data.

The model layer 806 implements the AI model 830 using data from the data layer 802 and the algorithm 816 and ML framework 814 from the structure layer 804, thus enabling decision-making capabilities of the AI system 800. The model layer 806 includes a model structure 820, model parameters 822, a loss function engine 824, an optimizer 826, and a regularization engine 828.

The model structure 820 describes the architecture of the AI model 830 of the AI system 800. The model structure 820 defines the complexity of the pattern/relationship that the AI model 830 expresses. Examples of structures that can be used as the model structure 820 include decision trees, support vector machines, regression analyses, Bayesian networks, Gaussian processes, genetic algorithms, and artificial neural networks (or, simply, neural networks). The model structure 820 can include a number of structure layers, a number of nodes (or neurons) at each structure layer, and activation functions of each node. Each node's activation function defines how the node converts data received to data output. The structure layers can include an input layer of nodes that receive input data, and an output layer of nodes that produce output data. The model structure 820 can include one or more hidden layers of nodes between the input and output layers. The model structure 820 can be an artificial neural network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 822 represent the relationships learned during training and can be used to make predictions and decisions based on input data. The model parameters 822 can weight and bias the nodes and connections of the model structure 820. For instance, when the model structure 820 is a neural network, the model parameters 822 can weight and bias the nodes in each layer of the neural network, such that the weights determine the strength of the nodes and the biases determine the thresholds for the activation functions of each node. The model parameters 822, in conjunction with the activation functions of the nodes, determine how input data is transformed into desired outputs. The model parameters 822 can be determined and/or altered during training of the algorithm 816.

The loss function engine 824 can determine a loss function, which is a metric used to evaluate the performance of the AI model 830 during training. For instance, the loss function engine 824 can measure the difference between a predicted output of the AI model 830 and the actual output of the AI model 830 and is used to guide optimization of the AI model 830 during training to minimize the loss function. The loss function can be presented via the ML framework 814, such that a user can determine whether to retrain or otherwise alter the algorithm 816 if the loss function is over a threshold. In some instances, the algorithm 816 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 826 adjusts the model parameters 822 to minimize the loss function during training of the algorithm 816. In other words, the optimizer 826 uses the loss function generated by the loss function engine 824 as a guide to determine what model parameters lead to the most accurate AI model 830. Examples of optimizers include Gradient Descent (GD), Adaptive Gradient Algorithm (AdaGrad), Adaptive Moment Estimation (Adam), Root Mean Square Propagation (RMSprop), Radial Base Function (RBF), and Limited-memory BFGS (L-BFGS). The type of optimizer 826 used can be determined based on the type of the model structure 820 and the size of data and the computing resources available in the data layer 802.

The regularization engine 828 executes regularization operations. Regularization is a technique that prevents over-and underfitting of the AI model 830. Overfitting occurs when the algorithm 816 is overly complex and too adapted to the training data, which can result in poor performance of the AI model 830. Underfitting occurs when the algorithm 816 is unable to recognize even basic patterns from the training data such that it cannot perform well on training data or on validation data. The regularization engine 828 can apply one or more regularization techniques to fit the algorithm 816 to the training data properly, which helps constrain the resulting AI model 830 and improves its ability for generalized application. Examples of regularization techniques include lasso (L1) regularization, ridge (L2) regularization, and elastic (L1 and L2) regularization.

In some implementations, the AI system 800 can include a feature extraction module implemented using components of the example computer system 900 illustrated and described in more detail with reference to FIG. 9. In some implementations, the feature extraction module extracts a feature vector from input data. The feature vector includes n features (e.g., feature a, feature b,. feature n). The feature extraction module reduces the redundancy in the input data, e.g., repetitive data values, to transform the input data into the reduced set of features such as a feature vector. The feature vector contains the relevant information from the input data, such that events or data value thresholds of interest can be identified by the AI model 830 by using this reduced representation. In some example implementations, the following dimensionality reduction techniques are used by the feature extraction module: independent component analysis, Isomap, kernel PCA, latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

### Computer System

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 shares a similar architecture as that of a server computer, PC, tablet computer, mobile telephone, game console, music player, wearable electronic device, network-connected (“smart”) device (e.g., a television or home assistant device), AR/VR system (e.g., head-mounted display), or any electronic device capable of executing a set of instructions that specify action(s) to be taken by the computing system 900. In some implementations, the computer system 900 can be an embedded computer system, a system-on-chip (SOC), a single-board computer (SBC) system, or a distributed system such as a mesh of computer systems, or include one or more cloud components in one or more networks. Where appropriate, one or more computer systems 900 can perform operations in real time, near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable (storage) medium 926) can be local, remote, or distributed. Although shown as a single medium, the machine-readable (storage) medium 926 can include multiple media (e.g., a centralized/distributed database and/or associated caches and servers) that store one or more sets of instructions 928. The machine-readable (storage) medium 926 can include any medium that is capable of storing, encoding, or carrying a set of instructions for execution by the computing system 900. The machine-readable (storage) medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number can also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A system for duplicating media using machine learning, the system comprising:
one or more processors; and
one or more non-transitory computer-readable storage media storing instructions that when executed by the one or more processors cause the one or more processors to perform operations comprising:
receiving, at a user device, a request for duplicating media previously generated on a remote device using a first instance of a generative model executing on the remote device;
extracting, from the request, parameters comprising: (a) a model identifier and (b) model-specific parameters, wherein the model-specific parameters include: (i) one or more prompts used in a previous session on the remote device to generate the media and (ii) a seed value indicative of randomized weights used in the first instance of the generative model;
identifying, using the model identifier, a second instance of the generative model from a plurality of generative models;
using the seed value to initialize a new session corresponding to the previous session of the first instance of the generative model during which the media was previously generated;
inputting the one or more prompts into the second instance of the generative model to generate regenerated media; and
generating one or more commands for causing the regenerated media to be rendered at the user device.

2. The system of claim 1, wherein the generative model comprises one or more of: a speech synthesis model, a music generation model, a video generation model, an image generation model, a diffusion model, or a foundation model.

3. The system of claim 1, wherein the request further includes one or more masks indicative of edits made to previously generated media at the remote device and wherein the instructions further cause the one or more processors to perform operations comprising:
applying the one or more masks to the regenerated media, wherein the one or more masks comprise at least one of a spectrogram mask, a time-domain mask, a frequency mask, or an alpha mask.

4. The system of claim 1, wherein the instructions further cause the one or more processors to perform operations comprising:
receiving, at the user device, one or more subsequent prompts for modifying the regenerated media;
inputting, into the second instance of the generative model, the one or more subsequent prompts to obtain a modified version of the regenerated media; and
generating one or more commands for causing the modified version of the regenerated media to be rendered at the user device.

5. The system of claim 4, wherein the request further comprises a sampler algorithm identifier and wherein the instructions further cause the one or more processors to perform operations comprising:
identifying, based on the sampler algorithm identifier, a sampler algorithm; and
applying the sampler algorithm to the second instance of the generative model.

6. A method for duplicating media using machine learning, the method comprising:
receiving, at a user device, a request for duplicating media previously generated on a remote device using a first model executing on a remote device;
extracting, from the request, parameters comprising (a) a model identifier and (b) model-specific parameters, wherein the model-specific parameters include (i) one or more prompts used in a previous session on the remote device to generate the media and (ii) a seed value indicative of randomized weights used in the first model;
identifying, using the model identifier, a second model corresponding to the first model from a plurality of models;
using the seed value to initialize a new session corresponding to the previous session of the first model during which the media was previously generated;
inputting the one or more prompts into the second model to generate regenerated media; and
generating one or more commands for causing the regenerated media to be rendered at the user device.

7. The method of claim 6, wherein the first model is a first instance of a generative model and the second model is a second instance of the generative model.

8. The method of claim 6, wherein the first model is a first instance of a generative model and wherein identifying the second model corresponding to the first model from a plurality of models further comprises:
determining whether a model from the plurality of models is a second instance of the generative model; and
based on determining that no model from the plurality of models is a second instance of the generative model, identifying the second model that meets a similarity criteria corresponding to the first model.

9. The method of claim 6, wherein the second model comprises one or more of: a speech synthesis model, a music generation model, a video generation model, an image generation model, a diffusion model, or a foundation model.

10. The method of claim 6, wherein the request further includes one or more masks indicative of edits made to previously generated media at the remote device and wherein the method further comprises:
applying the one or more masks to the regenerated media, wherein the one or more masks comprise at least one of a spectrogram mask, a time-domain mask, a frequency mask, or an alpha mask.

11. The method of claim 6, further comprising:
receiving, at the user device, one or more subsequent prompts for modifying the regenerated media;
inputting, into the second model, the one or more subsequent prompts to obtain a modified version of the regenerated media; and
generating one or more commands for causing the modified version of the regenerated media to be rendered at the user device.

12. The method of claim 6, wherein the request further comprises a sampler algorithm identifier and the method further comprises:
identifying, based on the sampler algorithm identifier, a sampler algorithm; and
applying the sampler algorithm to the second model.

13. The method of claim 6, further comprising: transmitting, to the remote device, a notification that the media was regenerated successfully.

14. One or more non-transitory, computer-readable storage media storing instructions that when executed by one or more processors cause the one or more processors to perform operations comprising:
receiving, at a user device, a request for duplicating media previously generated on a remote device using a first model executing on a remote device;
extracting, from the request, parameters comprising (a) a model identifier and (b) model-specific parameters, wherein the model-specific parameters include (i) one or more prompts used in a previous session on the remote device to generate the media and (ii) a seed value indicative of randomized weights used in the first model;
identifying, using the model identifier, a second model corresponding to the first model from a plurality of models;
using the seed value to initialize a new session corresponding to the previous session of the first model during which the media was previously generated;
inputting the one or more prompts into the second model to generate regenerated media; and
causing the regenerated media to be rendered at the user device.

15. The one or more non-transitory, computer-readable storage media of claim 14, wherein the first model is a first instance of a generative model and the second model is a second instance of the generative model.

16. The one or more non-transitory, computer-readable storage media of claim 14, wherein the first model is a first instance of a generative model and wherein identifying the second model corresponding to the first model from a plurality of models further causes the one or more processors to perform operations comprising:
determining whether a model from the plurality of models is a second instance of the generative model; and
based on determining that no model from the plurality of models is a second instance of the generative model, identifying the second model that meets a similarity criteria corresponding to the first model.

17. The one or more non-transitory, computer-readable storage media of claim 14, wherein the second model comprises one or more of: a speech synthesis model, a music generation model, a video generation model, an image generation model, a diffusion model, or a foundation model.

18. The one or more non-transitory, computer-readable storage media of claim 14, wherein the request further includes one or more masks indicative of edits made to previously generated media at the remote device and wherein the instructions further cause the one or more processors to perform operations comprising:
applying the one or more masks to the regenerated media, wherein the one or more masks comprise at least one of a spectrogram mask, a time-domain mask, a frequency mask, or an alpha mask.

19. The one or more non-transitory, computer-readable storage media of claim 14, wherein the instructions further cause the one or more processors to perform operations comprising:
receiving, at the user device, one or more subsequent prompts for modifying the regenerated media;
inputting, into the second model, the one or more subsequent prompts to obtain a modified version of the regenerated media; and
generating one or more commands for causing the modified version of the regenerated media to be rendered at the user device.

20. The one or more non-transitory, computer-readable storage media of claim 14, wherein the request further comprises a sampler algorithm identifier and wherein the instructions further cause the one or more processors to perform operations comprising:
identifying, based on the sampler algorithm identifier, a sampler algorithm; and
applying the sampler algorithm to the second model.
